(19) United States
(12) Patent Application Publication
(10) Pub. No.: US 2015/0135087 A1
(43) Pub. Date: May 14, 2015

(54) USER INTERFACE FOR SENSOR SYSTEM

(71) Applicant: Ceruus Oy, Liminka (FI)

(72) Inventor: Hannu Tapani VERKASALO, Liminka (FI)

(73) Assignee: Ceruus Oy, Liminka (FI)

(21) Appl. No.: 14/074,795

(22) Filed: Nov. 8, 2013

(51) Int. Cl. H04L 29/08; G06F 3/0484

(52) U.S. Cl. CPC H04L 67/125; G06F 3/0484
USPC 715/745

(57) ABSTRACT

A method, an apparatus, and a computer program for displaying application data associated with a sensor apparatus. The method includes: acquiring, by a user interface apparatus from a sensor apparatus, an identifier as a result of wireless communication between the user interface apparatus and the sensor apparatus; transmitting, by the user interface apparatus, the identifier to a server computer; receiving, by the user interface apparatus from the server computer, a user interface template configuration defining a user interface template corresponding to the identifier; and launching, by the user interface apparatus, a software application and configuring a display screen of the user interface apparatus to display a visual interface of the software application including the user interface template and application data in the user interface template.

### FIELD

The invention relates to sensor systems comprising at least one sensor apparatus and a user interface apparatus.

### BACKGROUND

Sensor systems may be employed to measure a determined physical property such as acceleration, temperature, or location. A sensor apparatus may comprise a sensor configured to measure the determined physical property. The sensor apparatus may be connected to a user interface apparatus configured to provide user interaction with a user. The user interface apparatus may be configured to output measurement data received from the sensor apparatus to the user.

### BRIEF DESCRIPTION

According to an aspect, there is provided a method comprising: acquiring, by a user interface apparatus from a sensor apparatus, an identifier as a result of wireless communication between the user interface apparatus and the sensor apparatus; transmitting, by the user interface apparatus, the identifier to a server computer; receiving, by the user interface apparatus from the server computer, a user interface template configuration defining a user interface template corresponding to the identifier; and launching, by the user interface apparatus, a software application and configuring a display screen of the user interface apparatus to display a visual interface of the software application comprising the user interface template and application data in the user interface template.

According to another aspect, there is provided an apparatus comprising: at least one processor; and at least one memory including a computer program code. The at least one memory and the computer program code are configured, with the at least one processor, to cause the apparatus to: acquire, from a sensor apparatus, an identifier as a result of wireless communication between the user interface apparatus and the sensor apparatus; transmit the identifier to a server computer; receive, from the server computer, a user interface template configuration defining a user interface template corresponding to the identifier; and launch a software application and configuring a display screen of the user interface apparatus to display a visual interface of the software application comprising the user interface template and application data in the user interface template.

According to another aspect, there is provided a computer program product embodied on a non-transitory distribution medium readable by a computer and comprising program instructions which, when loaded into an apparatus, execute a computer process comprising: acquiring, in a user interface apparatus from a sensor apparatus, an identifier as a result of wireless communication between the user interface apparatus and the sensor apparatus; transmitting, in the user interface apparatus, the identifier to a server computer; receiving, in the user interface apparatus from the server computer, a user interface template configuration defining a user interface template corresponding to the identifier; and executing, in the user interface apparatus, a software application and configuring a display screen of the user interface apparatus to display a visual interface of the software application comprising the user interface template and application data in the user interface template.

### BRIEF DESCRIPTION OF THE DRAWINGS

In the following the invention will be described in greater detail by means of preferred embodiments with reference to the attached drawings, in which

FIG. 1 illustrates a system according to an embodiment of the invention;

FIG. 2 illustrates a flow diagram of a process for mapping identifiers with user interface templates according to an embodiment of the invention;

FIG. 3 illustrates a flow diagram of a process for determining a user interface template from an identifier of a sensor apparatus according to an embodiment of the invention;

FIG. 4 illustrates a signalling diagram of a procedure for executing a software application displaying application data in a user interface template according to an embodiment of the invention;

FIGS. 5 and 6 illustrate some embodiments for different types of mappings between identifiers and user interface templates;

FIG. 7 illustrates an embodiment for determining a user interface template from an identifier of one or more sensor apparatuses; and

FIGS. 8 and 9 illustrate block diagrams of structures of apparatuses according to some embodiments of the invention.

### DETAILED DESCRIPTION OF THE INVENTION

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

FIG. 1 illustrates a system according to an embodiment of the invention. The system may comprise a sensor apparatus 102, a user interface apparatus 100, and a server computer, or a subset of these devices, e.g. only the user interface apparatus 100 or the user interface apparatus 100 and the sensor apparatus 102. The sensor apparatus 102 may be any apparatus provided with a sensor configured to measure a physical property and a wireless transceiver circuitry configured to communicate wirelessly with the user interface apparatus 100. The sensor may be configured to measure temperature, acceleration, air pressure, location, orientation, motion, sound, electrical current, acoustic noise, physiological properties such as heart rate or blood pressure, etc. In an embodiment, the sensor apparatus is a controller of a control system configured to measure a property and output a control signal to adjust at least one parameter of the control system on the basis of the measured property. An example of the control system is a temperature control system but the temperature control may be replaced by control of any other physical property.

The user interface apparatus 100 may be any apparatus comprising a display screen to output visual information to a user and a wireless transceiver circuitry configured to communicate wirelessly with the sensor apparatus 102 and, optionally, with the server computer 104. The communication with the server computer 104 may be realized through a wired connection from the user interface apparatus 100 towards the server computer 104. The user interface apparatus 100 may be a mobile phone, a tablet computer, a wrist computer, or any other portable user interface apparatus. The user interface apparatus may comprise at least one processor and at least one memory including a computer program code, wherein the at least one memory and the computer program code are configured, with the at least one processor, to cause the user interface apparatus to carry out the embodiments described below. The computer program code may comprise an operating system configured to manage hardware resources of the user interface apparatus 100 and provide common services for computer programs executed in the user interface apparatus. Examples of the operating systems configured to operate in portable apparatuses comprise iOS, Android, Windows Phone, Windows RT, BlackBerry OS, and Asha.

The computer program code may further comprise one or more software applications configured to acquire application data and display the application data to the user through the display screen and, optionally, other user interface components comprised in the user interface apparatus 100. The software applications may comprise a web browser configured to support browser-supported a computer programming language such as JavaScript combined with a browser-rendered mark-up language like hypertext mark-up language (HTML). The applications may further comprise web applications, wherein a web application may be defined as an application that uses the web browser as a client. The applications may further comprise software applications designed to run on portable apparatuses as stand-alone applications in the sense that they do not necessarily employ the web browser as the client. Such applications may be available through application distribution platforms such as the Apple App Store, Google Play, Windows Phone Store, and BlackBerry App World.

At least one of the applications executed in the user interface apparatus 100 may be configured to display application data acquired as a result of interaction between the user interface apparatus and the sensor apparatus 102. The sensor apparatus 102 may be sold or distributed under a brand which may be defined as a feature that makes one entity's sensor apparatus distinct from the sensor apparatuses of other entities. Instead of the seller, the entity associated with the brand may be a manufacturer or a distributor of the sensor apparatus or a community such as a sports club or a workplace. The entity may be understood as a company making commercial use in selling the sensor apparatuses, or the entity may be a company, community, a team, or a group purchasing the sensor apparatuses for commercial or non-commercial use. A common factor for the entities is that they each have the brand or the feature(s) that visually distinguishes the entity from other entities. The feature may comprise a name, term, design, and/or symbol unique to the entity behind the sensor apparatus 102. In an embodiment, the application executed in the user interface apparatus 100 and related to the interaction with the sensor apparatus 102 may be configured to display at least one of the features on the display screen.

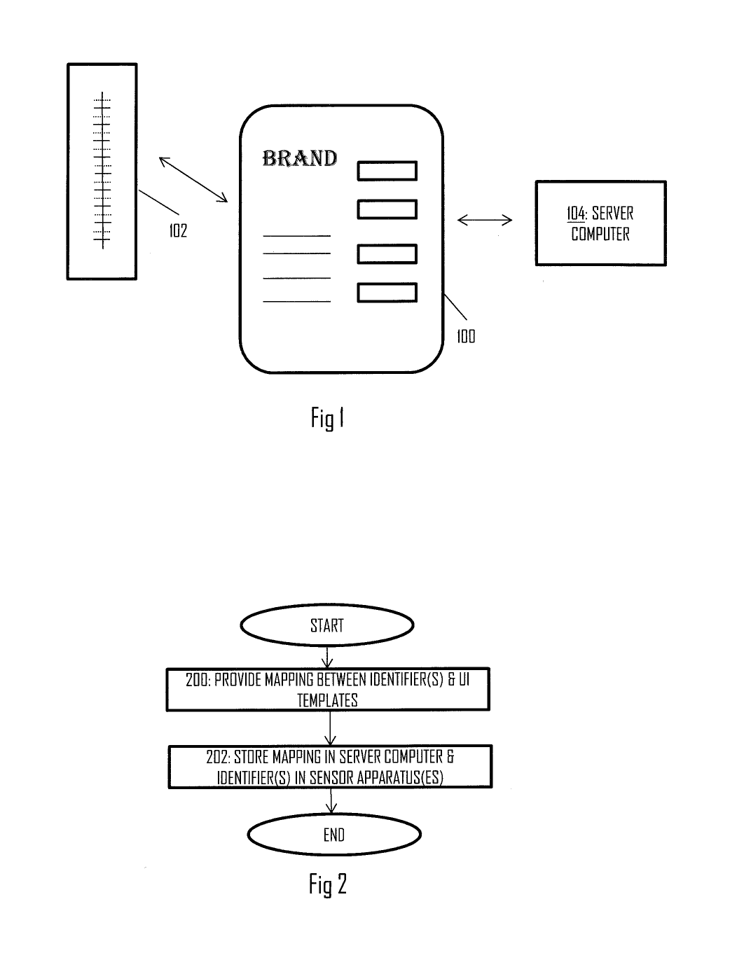

In an embodiment, the application is configured to support interaction with a plurality of sensor apparatuses of different brands. With reference to FIG. 2, let us now describe an embodiment of a method for associating sensor apparatuses of different brands with different display content displayed in the user interface apparatus 100. In block 200, the method comprises providing mapping between identifiers and user interface templates. Each identifier may be mapped to a user interface template. The user interface template may be brand-specific and customized uniquely for each brand. The identifier may be an arbitrary character string. In an embodiment, the identifiers are each mapped only to a single user interface template. In another embodiment, each brand may be associated with a plurality of different user interface templates and, accordingly, an identifier associated with such a brand may be mapped to a plurality of user interface templates. Block 200 may be performed by the server computer 104. In block 202, the mapping is stored in a memory of the server computer 104 for later reference. The identifiers may be stored in the sensor apparatuses such that one identifier may be stored in each sensor apparatus.

Let us now describe an embodiment of a method for selecting a user interface template for the application in the user interface apparatus 100. Referring to FIG. 2, the method comprises in the user interface apparatus 100: acquiring (block 300), from a sensor apparatus 102, an identifier as a result of wireless communication between the user interface apparatus 100 and the sensor apparatus 102; transmitting (block 302 the identifier to a server computer 104; receiving a user interface template configuration defining a user interface template corresponding to the identifier from the server computer (block 304); and launching a software application (block 306) and configuring (block 308) a display screen of the user interface apparatus 100 to display a visual interface of the software application comprising the user interface template and application data in the user interface template. Block 308 may be executed as a part of said launch of the software application in block 306.

The above-described embodiments enable the user interface apparatus 100 to adapt the visual interface defined by the user interface template to the sensor apparatus 102 that is in communication with the user interface apparatus 100 and from which the user interface apparatus 100 receives measurement data. In an embodiment, the application data comprises the measurement data received from the sensor apparatus 102. The adaptation may be realized by reading the identifier from the sensor apparatus 102 and requesting the server apparatus to indicate the user interface template matching with the identifier.

In an embodiment, block 300 to 304 may also be comprised in block 306, e.g. the launch of the software application may trigger the execution of block 300.

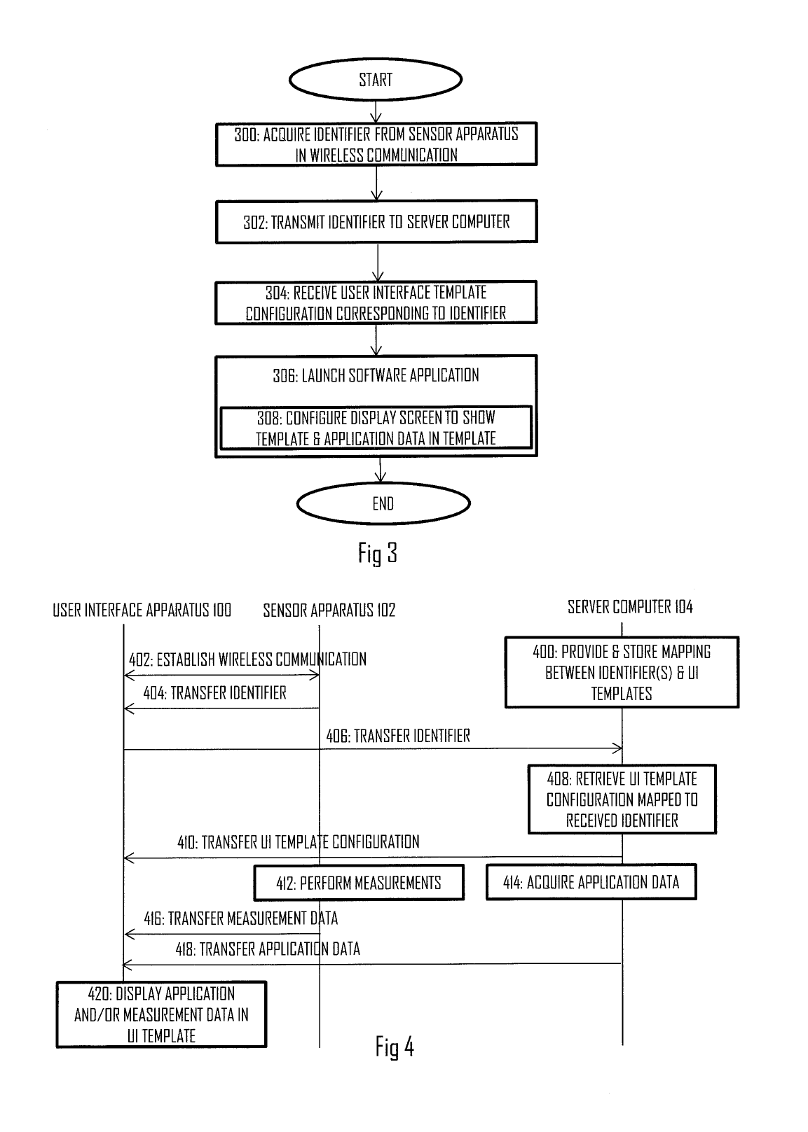

In an embodiment, the processes of FIGS. 2 and 3 may be executed for other apparatuses than the sensor apparatuses. In such embodiments, the user interface apparatus may connect to any other apparatus, receive an identifier from the other apparatus, and determine the user interface template on the basis of the received identifier.

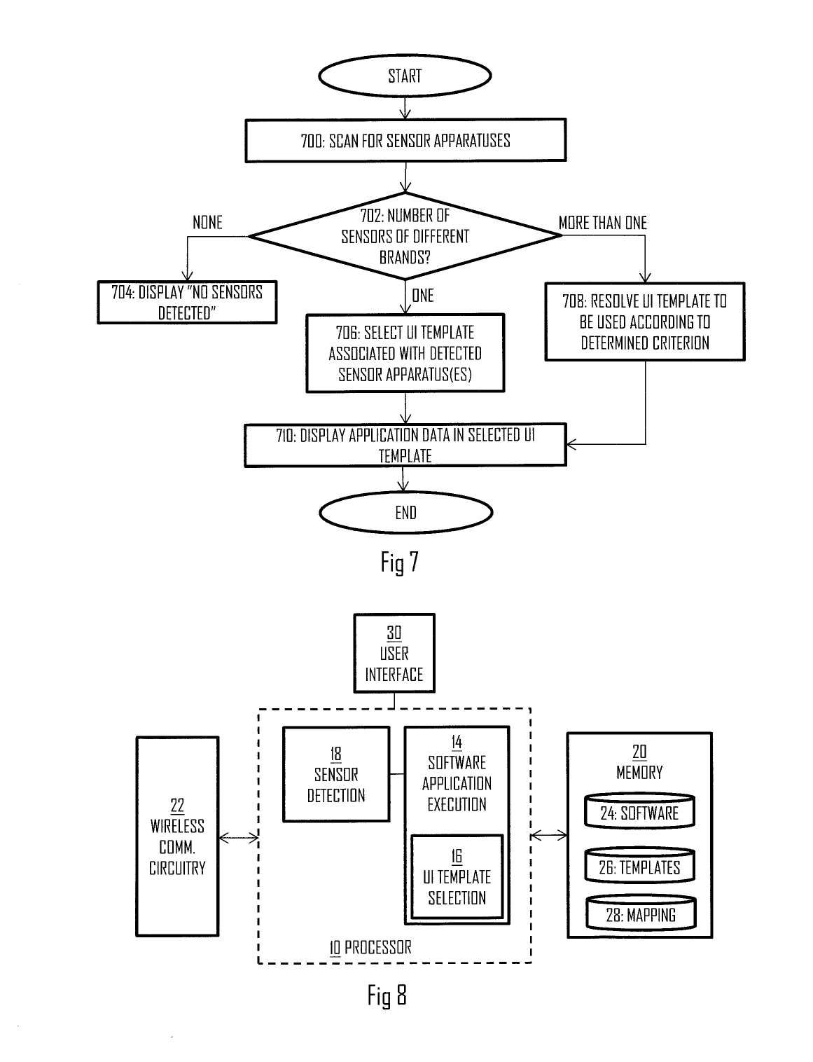

In an embodiment, the user interface apparatus may acquire a second user interface template configuration corresponding to a second identifier associated with a second sensor apparatus. Upon receiving the second user interface template configuration, the user interface apparatus may automatically make a selection between the user interface templates in the software application according to a determined criterion. FIG. 7 described in greater detail below illustrates an embodiment of making such a selection amongst a plurality of user interface template configurations received from the server computer.

In an embodiment, the user interface template configured sent by the server computer 104 and received by the user interface apparatus in block 304 comprises an information element specifying the user interface template, e.g. a template index or another template identifier. The user interface apparatus 100 may store in its memory mapping between a plurality of information elements and corresponding user interface templates and, upon receiving the information element, the user interface apparatus may check the memory for a user interface template matching with the received information element. Accordingly, the user interface apparatus may retrieve corresponding visual interface components from the memory. This reduces the amount of transferred data traffic because the visual interface components of different user interface templates may be stored in the user interface apparatus. The visual interface components may comprise a computer program code that forms a layout and display content displayed by the software application in the display screen. In another embodiment, the server computer may transmit and the user interface apparatus may receive such visual interface components of the user interface template in block 304, e.g. as html code.

In an embodiment, the user interface template forms a static part of the visual interface of the software application and the application data forms a dynamic part of the visual interface of the software application.

In an embodiment, the user interface template defines at least one of the following: a layout of the visual interface, colouring of the visual interface, details of at least one logo displayed in the visual interface, location of application data displayed in the visual interface, and a brand name displayed in the visual interface.

In an embodiment, the application data comprises at least one of measurement data received from the sensor apparatus 102 and application data received from the server computer 104. The application data received from the server computer may comprise micro-marketing data such as an advertisement message or other information specific to the customers. The application data may comprise messages exchanged internally between members of the same entity, e.g. a sports team. In this context, the software application may be a messaging application or at least have messaging features.

Let us now describe the procedure of matching the visual interface of the user interface apparatus with the sensor apparatus currently in wireless communication with the user interface apparatus in greater with reference to a signalling diagram of FIG. 4. Referring to FIG. 4, the server computer 104 may store the mapping between the identifiers and corresponding user interface template configurations in step 400 in the above-described manner. The user interface apparatus 100 may establish wireless communications with the sensor apparatus 102 in step 402. Step 402 may comprise establishment of a radio communication connection according to a determined communication protocol such as Bluetooth or Bluetooth Smart also known as Bluetooth Low Energy. In other embodiments, another communication protocol such as IEEE 802.15 or radio frequency identification (RFID) may be employed. Step 402 may be triggered by a user input launching the execution of the software application in the user interface apparatus 100. Upon establishing the wireless communication link between the user interface apparatus and the sensor apparatus, an identifier stored in the sensor apparatus may be transmitted by the sensor apparatus 102 and received by the user interface apparatus in step 404.

Upon acquiring the identifier from the sensor apparatus 102, the user interface apparatus may establish a communication connection with the server computer 104 and transmit the identifier to the server computer in step 406. The communication connection between the user interface apparatus and the server computer may comprise an internet protocol connection routed through the Internet, for example. The connection may comprise at least one radio link established according to a cellular communication protocol such as Global System for Mobile Communication or Universal Mobile Telecommunication System protocol or any one of their evolutions versions such as Long-Term Evolution (LTE). Another example of the protocol for the radio link is IEEE 802.11 (Wi-Fi). Upon receiving the identifier in step 406, the server computer may check its memory for a user interface template configuration mapped to the received identifier and retrieve the appropriate user interface template configuration in block 408. In step 410, the server computer may transmit the retrieved user interface template configuration to the user interface apparatus over the communication connection. Upon receiving the user interface template configuration in step 410, the user interface apparatus may launch the visual interface of the software application by applying the user interface template corresponding to the user interface template configuration received from the server computer 104. The user interface apparatus may configure the display screen to display a layout of the visual interface, colouring, and/or a brand symbol associated with the brand of the sensor apparatus 102 according to the applied user interface template. Upon creating the visual interface visually realizing the user interface template, the user interface apparatus may start gathering application data for display in the visual interface according to parameters specified by the user interface template. As described above, the application data may comprise measurement data measured by the sensor apparatus in block 412 and transferred from the sensor apparatus to the user interface apparatus in step 416. The application data may comprise application data generated in or acquired by the server computer 104 in block 414 and transferred from the server computer to the user interface apparatus in step 418. In block 420, the user interface apparatus may configure the display screen to display the application data received in step 416 and/or 418 according to the parameters of the user interface template.

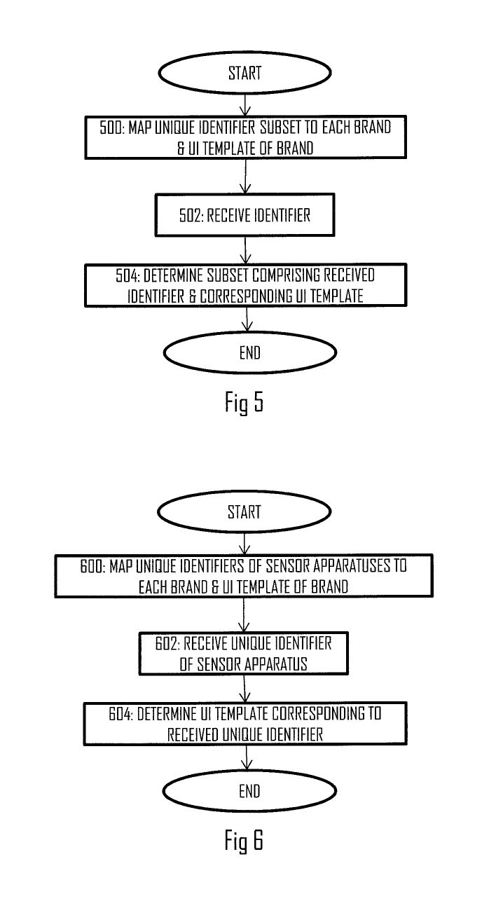

In an embodiment, the identifier is a unique identifier of the brand. In this embodiment, the identifier of the brand of the sensor apparatus may be stored in the sensor apparatus before the sensor apparatus is sold to a customer. Accordingly, the same identifier may be stored in a plurality of sensor apparatuses of the same brand. In another embodiment, the identifier is a unique identifier of the sensor apparatus. In this embodiment, the unique identifiers of the sensor apparatuses of a brand may be stored in the server computer as mapped to the user interface template(s) of the brand. FIGS. 5 and 6 illustrate procedures for carrying out the mapping in block 200 according to these embodiments. The procedures may be carried out by the server computer 104.

Referring to FIG. 5, a pool of identifiers may be distributed to different brands, each brand thus having a subset of identifiers of the pool. No two brands may have the same identifier in order to avoid selection of a wrong user interface template for a given brand. In block 500, the server computer 104 maps a unique identifier subset of a brand to one or more user interface templates of the brand. The server computer 104 may carry out the same procedure for the identifiers of the other brands. In block 502, the server computer receives an identifier from the user interface apparatus 100 (e.g. according to step 406). In block 504, the server computer determines a user interface template configuration mapped to the received identifier and transmits the user interface template configuration to the user interface apparatus.

Referring to FIG. 6, each brand may be associated with a subset of unique identifiers of sensor apparatuses, and the server computer 104 may store mapping between one or more user interface template associated with the brand and a subset of unique identifiers associated with the brand. The unique identifier may be a manufacturing serial number of the sensor apparatus 102 or a network address of the sensor apparatus, e.g. a medium access control (MAC) address. In block 600, the server computer 104 may map the unique identifiers of a plurality of sensor apparatuses to a user interface template associated with a given brand. The same procedure may be carried out for the other brands. In block 602, the server computer 104 receives a unique identifier of a sensor apparatus from the user interface apparatus 100 (e.g. according to step 406). In block 604, the server computer determines a user interface template configuration mapped to the received identifier and transmits the user interface template configuration to the user interface apparatus.

In an exemplary use scenario, the user may have acquired a plurality of sensor apparatuses of different brands and operate the sensor apparatuses with the same user interface apparatus and in the same software application. Accordingly, the user interface apparatus 100 may have retrieved a plurality of user interface template configurations from the server computer 104 and it should manage the display of the different user interface templates. In an embodiment, the user interface apparatus 100 may select a user interface template of a sensor apparatus that has been detected to be activated at the moment.

FIG. 7 illustrates an embodiment of a process for selecting a user interface template in the user interface apparatus 100. An initial situation may be that the user interface apparatus has established communication with at least a first and a second sensor apparatus of different sellers (step 402 for each sensor apparatus) and retrieved user interface template configurations corresponding to each sensor apparatus from the server computer 104 (step 410 for each sensor apparatus). Referring to FIG. 7, the process may be triggered by the user providing an input that launches the software application. In block 700, the user interface apparatus carries out scanning for sensor apparatuses. The user may instruct the user interface apparatus to pair with determined one or more sensor apparatuses by selecting an operational mode of the software application. Accordingly, the user interface apparatus may limit the scanning to a subset of sensor apparatuses with which it has previously established communication. In block 702, the user interface apparatus determines the number of sensor apparatuses of different brands that have been detected. If the user interface apparatus detects no sensor apparatuses, the process may proceed to block 704 in which the user interface apparatus may output a message to the user that no sensors were detected. If the user interface apparatus detects one sensor or a plurality of sensors mapped to the same user interface template, the process may proceed to block 706 in which the user interface apparatus selects the user interface template mapped to the detected sensor(s). In block 710, the user interface apparatus displays the application data in the selected user interface template. In an embodiment, the user interface apparatus detects presence of the first sensor apparatus and absence of a second sensor apparatus within a wireless communication range of the user interface apparatus (block 700). As a result of said detection, the user interface apparatus may select a user interface template associated with the first sensor apparatus for use in the software application.

If the user interface apparatus detects a plurality of sensors and at least two of the detected sensors are mapped to different user interface templates, the process may proceed to block 708 in which the user interface apparatus resolves the user interface template to be used according to a determined criterion. In an embodiment, the user interface apparatus 100 configures the display screen to display user interface template options to the user and receives a user selection of one of the proposed user interface templates through an input device of the user interface apparatus. In yet another embodiment, the user interface apparatus 100 configures the display screen to display a user interface template associated with a sensor apparatus that has been discovered first after launching the software application. In yet another embodiment, the user interface apparatus 100 determines the number of detected sensor apparatuses of each user interface template and selects a user interface template associated with the highest number of detected sensor apparatuses. In yet another embodiment, the user interface apparatus 100 configures the display screen to display at least one feature of a user interface template of each detected sensor apparatus. For example, associated with every detected sensor apparatus may be displayed in a blended view.

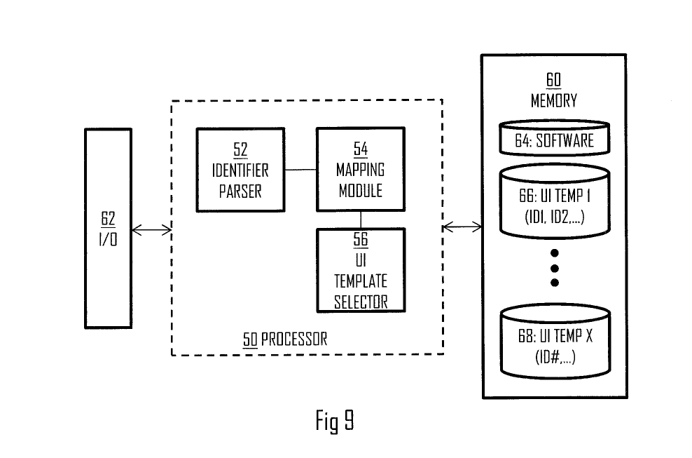

FIG. 8 illustrates an apparatus according to an embodiment of the invention. The apparatus may be the user interface apparatus 100 described above, or it may be comprised in the user interface apparatus 100, e.g. it may form a part of the user interface apparatus 100. In an embodiment, the apparatus is a peripheral device of the user interface apparatus connectable to the user interface apparatus.

The apparatus may comprise at least one processor 10 or processing circuitry and at least one memory 20 storing a computer program code 24 comprising computer program instructions. Upon reading the computer program code 24 by the processor 10, the processor is configured to carry out any one of the embodiments of the user interface apparatus described above. The processor may comprise as modules, e.g. computer program modules, a sensor detection module 18 configured to determine one or more sensor apparatuses currently in communication with the apparatus. The sensor detection module may configure a wireless communication circuitry 22 of the apparatus to scan for sensor apparatuses and establish wireless communication connectivity with the detected sensor apparatus(es). The sensor detection module may also acquire the identifier(s) from the sensor apparatus(es) and forward the detected identifiers to a software application execution module 14. In embodiments where the identifier used for determining the user interface template is not a unique identifier of the sensor apparatus, the sensor detection module may further acquire the unique identifier of the sensor apparatus and output also the unique identifier to the software application execution module 14. Accordingly, the unique identifier of the sensor apparatus may be mapped to the identifier determining the user interface template. Upon determining the user interface template, the unique identifier of the sensor apparatus may be used for determining the user interface template when the application is executed the next time. The software application execution module 14 may execute the above-described software application. The software application execution module 14 may control the operation of the sensor detection module 18. Upon receiving the identifier(s) from the sensor detection module, the software application execution module 14 may activate a user interface template selection module 16 configured to determine a user interface template for the received identifier. The user interface template selection module 16 may check a mapping table 28 stored in the memory for mapping between the received identifier and the user interface template. If the mapping table 28 does not store the mapping for the received identifier, the user interface template selection module 16 may configure the wireless communication circuitry 22 to establish a connection with the server computer 104 and transmit the received identifier to the server computer 104. Upon receiving the user interface template configuration for the identifier from the server computer 104, the user interface template selection module 16 may store the mapping in the mapping table 28 and configure a display screen of a user interface 30 to display the user interface template and application data in the user interface template. On the other hand, if the mapping table 28 stores the mapping for the received identifier, the user interface template selection module 16 may select the user interface template without connecting first to the network server 104.

The user interface 30 may comprise the display screen and, additionally, a user input device such as one or more buttons, a touch-sensitive display, or a pointing device. The wireless communication circuitry 22 may comprise radio transceiver circuitries needed for establishing wireless communication connections with the sensor apparatuses and, optionally, the network server 104 according to one or more determined communication protocols. The radio transceiver circuitries may comprise standard components for radio frequency and baseband signal processing.

FIG. 9 illustrates an apparatus according to another embodiment of the invention. The apparatus may be the server computer 104 described above, or it may be comprised in the server computer 104, e.g. it may form a part of the server computer 104. The apparatus may comprise at least one processor or processing circuitry 50 and at least one memory 60 storing a computer program code 64 comprising computer program instructions. Upon reading the computer program code 64 by the processor 50, the processor 50 is configured to carry out any one of the embodiments of the server computer 104 described above. The processor 50 may comprise as modules, e.g. computer program modules, an identifier parser 52 configured to extract an identifier from a message received from a user interface apparatus 100 through input/output (I/O) interface components 62 of the apparatus. The I/O interface components 62 may comprise communication circuitries necessary for establishing a connection to the Internet, e.g. according to the internet protocol. Upon extracting the identifier, the identifier parser 52 may output the identifier to a mapping module 54 configured to cross-reference the identifier to mapping records 66, 68 stored in the memory. Each mapping record 66, 68 may store mapping between a user interface template configuration and one or more identifiers. The mapping records 66, 68 may form a mapping table. The mapping module 54 may search the mapping records 66, 68 for a user interface template configuration mapped to the received identifier. Upon finding a correct mapping, the mapping module 54 may configure a user interface template selector 56 to retrieve the corresponding user interface template configuration from the memory and transmit the user interface template configuration to the user interface apparatus through the I/O interface 62.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 2 to 7 may also be carried out in the form of one or more computer processes defined by one or more computer programs. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The purpose of the description above is to merely illustrate some embodiments of the invention. Therefore, all words and expressions should be interpreted broadly and they are intended not to restrict the embodiments. It will be obvious to a person skilled in the art that, as technology advances, the inventive concept can be implemented in various ways. The invention and its embodiments are not limited to the examples described above but may vary within the scope of the claims.

1. A method comprising:
acquiring, by a user interface apparatus from a sensor apparatus, an identifier as a result of wireless communication between the user interface apparatus and the sensor apparatus;
transmitting, by the user interface apparatus, the identifier to a server computer;
receiving, by the user interface apparatus from the server computer, a user interface template configuration defining a user interface template corresponding to the identifier; and
launching, by the user interface apparatus, a software application and configuring a display screen of the user interface apparatus to display a visual interface of the software application comprising the user interface template and application data in the user interface template.

2. The method of claim 1, wherein the user interface template forms a static part of the visual interface of the software application and the application data forms a dynamic part of the visual interface of the software application.

3. The method of claim 1, wherein said user interface template is a first user interface template and said sensor apparatus is a first sensor apparatus, the method further comprising in the user interface apparatus:
acquiring a second user interface template corresponding to a second identifier associated with a second sensor apparatus;
automatically making a selection between the first user interface template and the second user interface template in the software application according to a determined criterion.

4. The method of claim 3, further comprising in the user interface apparatus:
detecting presence of the first sensor apparatus and absence of the second sensor apparatus within a wireless communication range of the user interface apparatus; and
determining, as a result of said detection, a user interface template associated with the first sensor apparatus; and
selecting the determined user interface template of the first sensor apparatus for the software application.

5. The method of claim 1, wherein the application data comprises a micro-marketing message received in the user interface apparatus.

6. The method of claim 1, wherein the application data comprises measurement data received from the sensor apparatus.

7. The method of claim 1, wherein the identifier is associated with a brand and wherein the user interface template is matched with the brand associated with the identifier.

8. The method of claim 7, wherein the identifier is unique for each brand and a plurality of sensor apparatuses associated with the same brand store the same identifier.

9. The method of claim 7, wherein the identifier is a unique identifier of the sensor apparatus, wherein each brand is associated with a subset of unique identifiers, and wherein the server computer stores mapping between each brand and a subset of unique identifiers associated with each brand.

10. The method of claim 1, wherein the user interface template defines at least one of the following: a layout of the visual interface, colouring of the visual interface, details of at least one logo displayed in the visual interface, location of application data displayed in the visual interface, and a brand name displayed in the visual interface.

11. An apparatus comprising:
at least one processor; and
at least one memory including a computer program code, wherein the at least one memory and the computer program code are configured, with the at least one processor, to cause the apparatus to:
acquire, from a sensor apparatus, an identifier as a result of wireless communication between the user interface apparatus and the sensor apparatus;
transmit the identifier to a server computer;
receive, from the server computer, a user interface template configuration defining a user interface template corresponding to the identifier; and
launch a software application and configuring a display screen of the user interface apparatus to display a visual interface of the software application comprising the user interface template and application data in the user interface template.

12. The apparatus of claim 11, wherein the user interface template forms a static part of the visual interface of the software application and the application data forms a dynamic part of the visual interface of the software application.

13. The apparatus of claim 11, wherein said user interface template is a first user interface template and said sensor apparatus is a first sensor apparatus, wherein the at least one memory and the computer program code are configured, with the at least one processor, to cause the apparatus to:
acquire a second user interface template corresponding to a second identifier associated with a second sensor apparatus;
automatically make a selection between the first user interface template and the second user interface template in the software application according to a determined criterion.

14. The apparatus of claim 13, wherein the at least one memory and the computer program code are configured, with the at least one processor, to cause the apparatus to:
detect presence of the first sensor apparatus and absence of the second sensor apparatus within a wireless communication range of the user interface apparatus; and
determine, as a result of said detection, a user interface template associated with the first sensor apparatus; and
select the determined user interface template of the first sensor apparatus for the software application.

15. The apparatus of claim 11, wherein the application data comprises a micro-marketing message received in the user interface apparatus.

16. The apparatus of claim 11, wherein the identifier is associated with a brand and wherein the user interface template is matched with the brand associated with the identifier.

17. The apparatus of claim 16, wherein the identifier is unique for each brand and a plurality of sensor apparatuses associated with the same brand store the same identifier.

18. The apparatus of claim 16, wherein the identifier is a unique identifier of the sensor apparatus, wherein each brand is associated with a subset of unique identifiers, and wherein the server computer stores mapping between each brand and a subset of unique identifiers associated with each brand.

19. The apparatus of claim 11, wherein the user interface template defines at least one of the following: a layout of the visual interface, colouring of the visual interface, details of at least one logo displayed in the visual interface, location of application data displayed in the visual interface, and a brand name displayed in the visual interface.

20. A computer program product embodied on a non-transitory distribution medium readable by a computer and comprising program instructions which, when loaded into an apparatus, execute a computer process comprising:
acquiring, in a user interface apparatus from a sensor apparatus, an identifier as a result of wireless communication between the user interface apparatus and the sensor apparatus;
transmitting, in the user interface apparatus, the identifier to a server computer;
receiving, in the user interface apparatus from the server computer, a user interface template configuration defining a user interface template corresponding to the identifier; and
executing, in the user interface apparatus, a software application and configuring a display screen of the user interface apparatus to display a visual interface of the software application comprising the user interface template and application data in the user interface template.
